(19) United States
(12) Patent Application Publication
(10) Pub. No.: US 2024/0361997 A1
(43) Pub. Date: Oct. 31, 2024

(54) Application Program Construction and Execution Methods and Systems

(71) Applicant: Siemens Aktiengesellschaft, München (DE)

(72) Inventors: Dong Li, Beijing (CN); Xiao Bo Yang, Beijing (CN); Jian Yong Zhang, Beijing (CN); Tong Zhou Wang, Beijing (CN); Chuan Yu Zhang, Beijing (CN); Yao Lei Kang, Beijing (CN)

(73) Assignee: Siemens Aktiengesellschaft, München (DE)

(21) Appl. No.: 18/565,154

(22) PCT Filed: May 31, 2021
(86) PCT No.: PCT/CN2021/097457

§ 371 Date: Nov. 29, 2023

(51) Int. Cl. G06F 8/36; G06F 8/71

(52) U.S. Cl. CPC G06F 8/36; G06F 8/71

(57) ABSTRACT

Various teachings of the present disclosure include an application program construction method. An example may include: determining a plurality of functional modules constituting an application program; attaching a pre-configured communication component to each functional module; establishing a connection relationship between the functional modules by using the communication components; and storing the connection relationship in a configuration file.

### CROSS-REFERENCE TO RELATED APPLICATIONS

This application is a U.S. National Stage Application of International Application No. PCT/CN2021/097457 filed May 31, 2021, which designates the United States of America, the contents of which are hereby incorporated by reference in their entirety.

### TECHNICAL FIELD

The present disclosure generally relates to the technical field of industrial Internet of Things. Various embodiments of the teachings herein include application program construction methods and systems as well as execution methods and systems.

### BACKGROUND

As software becomes larger and larger and the time to market becomes shorter, modular programming has become an important way of software design and implementation technology. Its purpose is to divide the functions of a program into independent and replaceable modules. In this way, developers can develop application programs in parallel and improve the reusability of each module, thereby reducing the time to market of the application program.

A Robot Operating System (ROS) is a flexible framework for writing robot software. The ROS is a collection of tools, libraries, and events designed to simplify the task of producing complex and robust robot behavior across various robot platforms. However, if it is not used for robot applications, there are limitations of the operating system and programming language.

Node-RED is a programming tool in the prior art that connects hardware devices, APIs and online services. An application program can be simply synthesized by using existing nodes in the Node-RED. However, developing a new node requires a larger workload. (Only JavaScript language can be used to develop limited application functions. Developing core functions requires a larger workload, such as understanding module API, storage API, HTTP API and context API, etc.)

### SUMMARY

A brief summary of the present invention will be presented below, so as to provide a basic understanding of certain aspects of the present disclosure. It should be understood that this summary is not an exhaustive overview of the teachings herein. It is not intended to determine key or critical elements to define the scope of the present disclosure. The purpose of the summary is merely to present some concepts in a simplified form as a prelude to the more detailed description that will be discussed later.

In view of this, the present disclosure described lightweight distributed application program construction methods and systems, which can integrate functional modules into an application program and realize communication between functional modules. For example, some embodiments include an application program construction method comprising: determining a plurality of functional modules that constitute an application program; attaching a pre-configured communication component to each functional module; and establishing a connection relationship between the functional modules by using the communication components, and storing the connection relationship in a configuration file.

In some embodiments, the functional modules are threads or processes that implement independent functions.

In some embodiments, the communication component comprises at least one of an input communication interface and an output communication interface.

In some embodiments, the communication component further comprises: at least one of a monitoring module, a caching module, and a load balancing module.

In some embodiments, the method further comprises modifying execution logic of the application program by modifying the configuration file.

As another example, some embodiments include an execution method of an application program, the application program being constructed using the application program construction method as described above, the execution method for the application program comprising: initializing the application program, and loading an application program configuration file; when a first functional module of the application program receives data, triggering execution of the first functional module; and sending, by the first functional module, data to a pre-configured port in an output communication interface of the first functional module according to an execution result of the first functional module, so as to trigger execution of a second functional module bound to the port, sending, by the second functional module, data to a pre-configured port in an output communication interface of the second functional module according to an execution result of the second functional module, so as to trigger execution of a third functional module bound to the port, and so on, until execution of the application program ends.

As another example, some embodiments include a computing device, comprising: at least one processor; and a memory coupled to the at least one processor, the memory being used for storing instructions that, when executed by the at least one processor, cause the processor to perform one or more of the methods as described herein.

As another example, some embodiments include a non-transitory machine-readable storage medium storing executable instructions that, when executed, cause the machine to perform one or more of the methods as described herein.

As another example, some embodiments include a computer program, comprising computer-executable instructions that, when executed, cause at least one processor to perform one or more of the method as described herein.

As another example, some embodiments include a computer program product tangibly stored on a computer-readable medium and comprising computer-executable instructions that, when executed, cause at least one processor to perform one or more of the methods as described herein.

### BRIEF DESCRIPTION OF THE DRAWINGS

The above and other objects, features, and potential advantages of the teachings of the present disclosure will be more easily understood with reference to the following description of example embodiments in conjunction with the drawings. The components in the drawings are merely illustrative of the principles of the present disclosure. In the drawings, the same or similar technical features or components will be denoted by the same or similar reference signs. In the drawings:

FIG. 1 is a flowchart showing an exemplary process of an application program construction method incorporating teachings of the present disclosure;

FIG. 2 is a schematic diagram showing a specific example of a gateway application program constructed using a method incorporating teachings of the present disclosure;

FIG. 3 shows a flowchart of an exemplary process of an execution method of an application program constructed according to a method incorporating teachings of the present disclosure;

FIG. 4 shows a block diagram of an example computing device for executing an application program incorporating teachings of the present disclosure.

In the figures, the reference signs are as follows:

| | |
|---|---|
| 100: Application program | S102, S104, S106 and S108: |
| construction method | Step |
| 200: Gateway application | M1, M2, M3, M4, M5, |
| program | M6 and M7: Function module |
| OCI: Output communication | ICI: Input communication |
| interface | interface |
| 300: Application program | S302, S304, and S306: Step |
| execution method | 402: Processor |
| 400: Computing device | |
| 404: Memory | |

### DETAILED DESCRIPTION

Developers can use any programming language to develop functional modules in parallel, reducing the dependencies between functional modules. The developers only need to focus on the functions to be implemented by the functional modules without caring about the details of communication. The functional modules can be deployed on one machine or a plurality of different machines without changing any code.

The developers can modify the execution logic of the application program by modifying the configuration file, and can dynamically adjust, by modifying the configuration file, the communication methods between the functional modules, such as shared memory, IPC or socket, etc. Function modules of new device can be easily added without affecting the execution of the application program.

With the caching module, even if a functional module has a fault, the execution of other functional modules of the application program will not be interrupted, and no data will be lost.

The subject matter described herein is now discussed with reference to exemplary embodiments. It should be understood that these embodiments are discussed purely in order to enable those skilled in the art to better understand and thus implement the subject matter described herein, without limiting the protection scope, applicability or examples expounded in the claims. The functions and arrangement of the elements discussed can be changed without departing from the scope of protection of the content of the present disclosure. Various processes or components can be omitted from, replaced in or added to each example as required. For example, the method described may be performed in a different order from that described, and all of the steps may be added, omitted or combined. In addition, features described in relation to some examples may also be combined in other examples.

As used herein, the term “comprises” and variants thereof denote open terms, meaning “including but not limited to”. The term “based on” means “at least partly based on”. The terms “one embodiment” and “an embodiment” mean “at least one embodiment”. The term “another embodiment” mean “at least one other embodiment”. The terms “first”, “second”, etc. may denote different or identical objects. Other definitions may be included below, either explicit or implicit. Unless clearly indicated in the context, the definition of a term is the same throughout the specification.

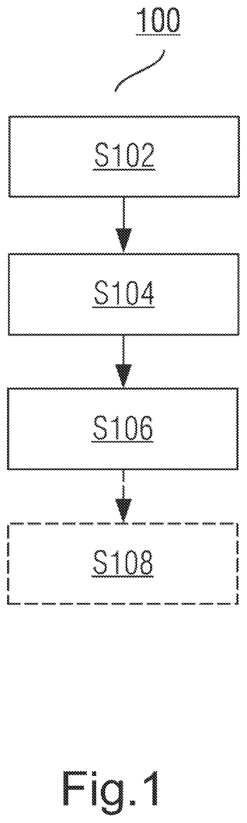

In some embodiments of the teachings herein, there is a lightweight distributed application program construction method, which can integrate functional modules into an application program and realize communication between functional modules. The application program construction methods and execution methods incorporating teachings of the present disclosure are described in detail below with reference to the drawings. FIG. 1 shows a flowchart of an exemplary process of an application program construction method 100 incorporating teachings of the present disclosure.

First, in step S102, a plurality of functional modules constituting an application program are determined. The application program is first divided into a plurality of independent functional modules according to the functions of the application program. In this way, different functional modules may be developed in parallel by a plurality of developers, and each developed module has better reusability. Each module implements an independent function, and may be a process running alone or a thread running together with other modules.

Next, in step S104, a pre-configured communication component is attached to each functional module. One functional module and other functional modules establish connections therebetween and exchange data through communication components. The communication component is a pre-configured communication library, which may include a plurality of functions to implement different functions. Moreover, the communication library may support function modules using different programming languages. Therefore, there is no restriction on the programming language used by developers to develop function modules.

The communication component may be pre-configured by a person skilled in the art, and a plurality of versions may be provided for functional modules in different programming languages. The specific implementation of the communication component is not limited in the method and will not be described in detail here. In order to implement scheduling between functional modules, the communication component attached to the functional modules at least includes at least one of an input communication interface and an output communication interface. According to the functions to be implemented by the modules, only the input communication interface or the output communication interface may be attached, or both may be attached.

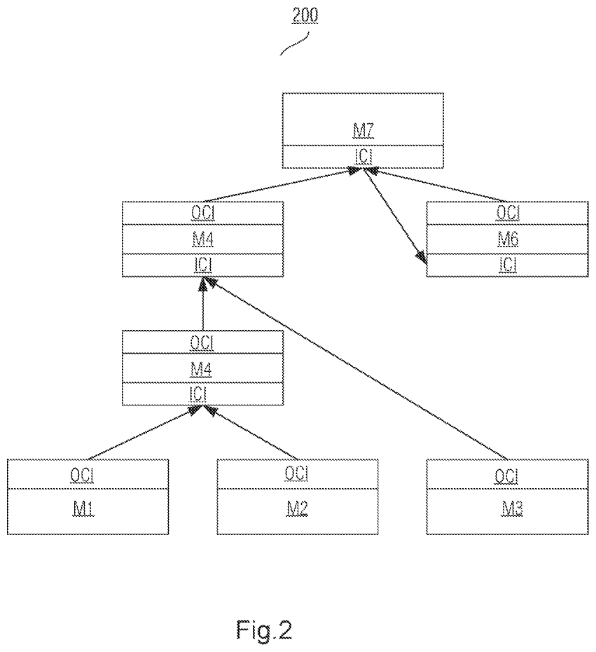

For example, in an example of a gateway application program shown in FIG. 2 below, as a data source of the application program, a functional module that obtains data from an external device may only be attached with an output communication interface and establishes a connection with other functions of the application program through the output communication interface. As a functional module of a data pool, it may only be attached with an input communication interface and receive data from other functional modules through the input communication interface for storage.

In step S106, the communication component of the functional module is used to establish a connection relationship between the functional modules, and the connection relationship is stored in a configuration file.

Through the steps described herein, a plurality of functional modules can be constructed into an application program. The functional modules establish connections and exchange data through communication components. In an example, the communication component may also include at least one of a monitoring module, a caching module, a load balancing module, etc. The monitoring module is used to monitor whether the connection between two functional modules is normal. The caching module can cache data to be sent or received data. Using the cache, hot switching of functional modules can be realized. When a functional module is replaced, no messages will be lost, and other functional modules can still run. The load balancing module is used to balance the load between functional modules. When the business volume is large, a plurality of identical functional modules can be used to handle time-consuming work. The monitoring module, caching module, and load balancing module may each be set in the input communication interface and the output communication interface.

In an example, the application program construction method 100 further includes step S108: modifying execution logic of the application program by modifying the configuration file. For example, when adding a function module, modifying a port of the function module for receiving data, modifying a calling relationship of the function module, etc., they all can be achieved by modifying the configuration file.

FIG. 2 is a schematic diagram of a specific example of a gateway application 200 constructed using a method incorporating teachings of the present disclosure. The specific process of constructing an application program will be further described below with reference to the specific example in FIG. 2.

It is assumed that the gateway application program 200 includes seven functional modules: M1, M2, M3, M4, M5, M6 and M7. Among them, M1, M2, M3 and M6 are data sources of the application program that obtain data from an external device; M7 is a data pool, which receives and stores data; M4 and M5 are data filters that process data according to certain logic. Each functional module is attached with a communication component, where the reference sign OCI denotes the output communication interface, and ICI denotes the input communication interface. It can be understood that for different functional modules, specific contents included in OCI and ICI may be different, but similar functions are implemented, so they are not distinguished in the reference signs herein. According to the different functions implemented by the functional modules, M1, M2, and M3 are only attached with the output communication interface OCI, M7 is only attached with the input communication interface ICI, and M4, M5, and M6 are attached with both the output communication interface OCI and the input communication interface ICI.

In the configuration file shown below, it is separately configured for each functional module. In the configuration information of M1, c indicates that M1 serves as a client, and its output interface parameter is ‘tcp://localhost: 5557’. This parameter indicates that M1 is to be connected to a service provided by port “5557”. According to the configuration file, it can be seen that M1 is connected to M4. In the configuration information of M4, b indicates binding ‘tcp://*:5557’, that is, M4 provides a service through port 5557, and M4 is connected to a service provided by port 5558, that is, M4 is connected to M5. The configuration information of other functional modules will not be described in detail here. Through this configuration file, the connection relationship between functional modules as shown in FIG. 2 can be obtained.

### Configuration File for the Gateway Application Program:

```
config globals ‘M1’
  option ‘c’ ‘tcp:// localhost:5557’
config globals ‘M2’
  option ‘c’ ‘tcp://localhost:5557’
config globals ‘M3’
  option ‘c’ ‘tcp://localhost:5558’
config globals ‘M4’
  option ‘b’ ‘tcp://*:5557’
    option ‘c’ ‘tcp://localhost:5558’
config globals ‘M5’
  option ‘b’ ‘tcp://*:5558’
      option ‘c’ ‘tcp://localhost:5559’
config globals ‘M6’
    option ‘b’ ‘tcp://*:5560’
  option ‘c’ ‘tcp://localhost:5559’
config globals ‘M7’
  option ‘b’ ‘tcp://*:5559’
    option ‘c’ ‘tcp://localhost:5560’
```

If a new device is to be connected to the gateway, in a new function module, the developers only need to implement codes related to the hardware of the new device, then attach a communication component to it, and configure the function modules of the new device in the configuration file of the application program. When adding the new function module, function modules M4-M7 can be reused without any changes or even restarting the application program. If a data filter module, such as M5, needs to be replaced, M4 and M7 will not stop working when M5 stops working. The data of M4 will be temporarily stored in the caching module of the communication component. When the newly replaced functional module M5 starts working, the connection between M4 and M5 will be automatically established according to the connection relationship in the configuration file. At this time, the cached data will be resent to the new M5. When M5 stops working, M7 continues to receive data from other functional modules without being affected.

The application programs described herein are event-triggered data flows, that is, when a functional module receives data, the execution of the application program can be triggered.

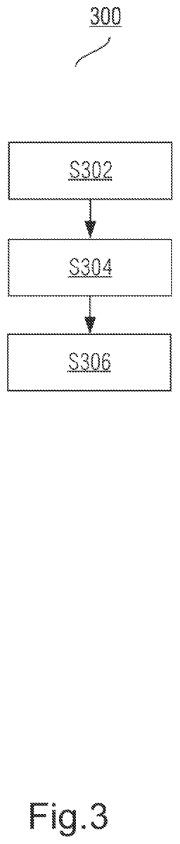

The execution process of the application program constructed according to a method incorporating teachings of the present disclosure is described below with reference to FIG. 3. FIG. 3 shows a flowchart of an exemplary process of an execution method 300 of an application program constructed according to a method incorporating teachings of the present disclosure.

First of all, in step S302, the application program is initialized and the configuration file of the application program is loaded. Specifically, in the initialization phase of the application program, in addition to executing an initialization function of the application program, the configuration file of the application program needs to be loaded. The configuration file described here is a configuration file configuring the connection relationship between various functional modules as described above.

In some embodiments, a module configuration file may also be loaded during the initialization phase. The module configuration file is a file that configures internal parameters of a module. The same functional module may have a plurality of instances, and each instance may have the same or different module configuration files.

Next, in step S304, when a first functional module of the application program receives data, the execution of the first functional module is triggered. The first functional module here does not refer to a specific functional module. When a certain functional module of the application receives data, it triggers the execution of the functional module, which in turn triggers the execution of the application program. Then, the functional module is called a first functional module. The first functional module, the second functional module and the third functional module in the following are only to distinguish different functional modules and do not refer to specific functional modules. There is no specific order for the execution of various functional modules.

In addition to supporting a client/server (C/S) mechanism, the application program also supports a subscription/publishing (Pub/Sub) mechanism. In this case, when an event about a specific topic is received, the execution of the function module is triggered.

Finally, in step S306, the first functional module sends data to a pre-configured port in an output communication interface of the first functional module according to an execution result of the first functional module, so as to trigger execution of a second functional module bound to the port, the second functional module sends data to a pre-configured port in an output communication interface of the second functional module according to an execution result of the second functional module, so as to trigger execution of a third functional module bound to the port, and so on, until execution of the application program ends.

A specific example of the execution process of the gateway application program will be described below with reference to FIG. 2 again. First of all, assuming that the function module M1 receives alarm data from an external sensor, the execution of M1 is triggered. The execution result of M1 is sent to port ‘5557’ through its output communication interface, that is, it is sent to the input communication interface of the function module M4, and then the execution of M4 is triggered.

The execution result of M4 is sent to port ‘5558’ through its output communication interface, that is, it is sent to the input communication interface of the function module M5, and then the execution of M5 is triggered. Next, the execution result of M5 is sent to port ‘5559’ through its output communication interface, that is, it is sent to the input communication interface of the function module M7. M7 stores the received data without sending it to other functional modules, and the gateway application program ends. After a period of time, it is possible that the function module M2 receives the data, and then a new execution process of the application program is triggered.

It can be seen that the application program constructed according to an application program construction method incorporating teachings of the present disclosure is triggered based on data or an event. There is no order in which the functional modules are started, and they may also be executed in parallel.

By reducing the dependencies between modules, the developers can develop in parallel, can use any programming language to develop functional modules, and only needs to focus on the functions to be implemented by the functional modules without caring about the details of communication. The functional modules can be deployed on one machine or a plurality of different machines without changing any code.

The developers can modify the execution logic of the application program by modifying the configuration file, and can dynamically adjust, by modifying the configuration file, the communication methods between the functional modules, such as shared memory, IPC or socket, etc. Function modules of new device can be easily added without affecting the execution of the application program.

With the caching module, even if a functional module has a fault, the execution of other functional modules of the application program will not be interrupted, and no data will be lost.

The application program construction method and the application program execution methods have been described above with reference to FIGS. 1 to 3. The application execution method described above may be implemented using software or a combination of hardware and software.

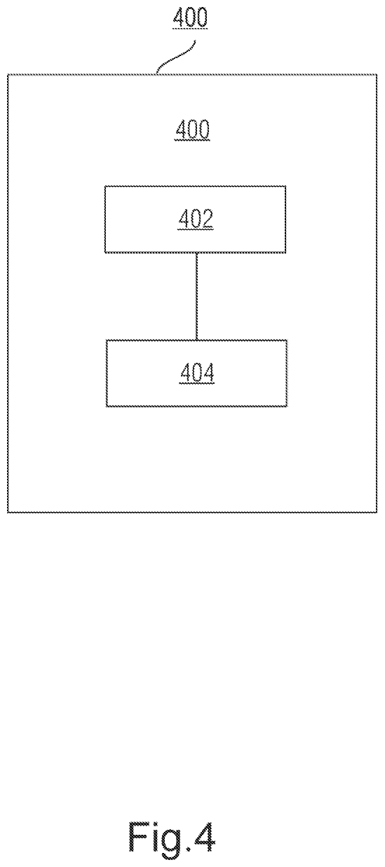

FIG. 4 shows a block diagram of an example computing device 400 for executing an application program incorporating teachings of the present disclosure. In some embodiments, the computing device 400 may include at least one processor 402 that executes at least one computer-readable instructions (i.e., elements implemented in the software form described above) stored or encoded in a computer-readable storage medium (i.e., a memory 404).

It should be understood that the computer-executable instructions stored in the memory 404, when executed, cause at least one processor 402 to perform various operations and functions described above with reference to FIG. 3 in various embodiments of the present disclosure.

In some embodiments, a non-transitory machine-readable medium may have machine-executable instructions (i.e., the elements implemented in the software form described above) that, when executed by a machine, cause the machine to perform various operations and functions described above with reference to FIG. 3 in various embodiments of the present disclosure.

In some embodiments, a computer program includes computer-executable instructions that, when executed, cause at least one processor to perform various operations and functions described above with reference to FIG. 3 in various embodiments of the present disclosure.

In some embodiments, a computer program product includes computer-executable instructions that, when executed, cause at least one processor to perform various operations and functions described above with reference to FIG. 3 in various embodiments of the present disclosure.

It should be understood that various embodiments in the description are described in a progressive manner, and the same or similar parts between the various embodiments can be referred to each other.

The emphasis of each embodiment is to describe the differences from other embodiments. For example, for the above-mentioned embodiments regarding apparatuses, embodiments regarding computing devices, and embodiments regarding machine-readable storage media, since they are basically similar to the method embodiments, they are relatively simply described. For relevant details, please refer to part of the description of the method embodiments.

Specific embodiments of the description have been described above. Other embodiments are within the scope of the appended claims. In some cases, the actions or steps recited in the claims may be performed in a different order from that in the embodiments and still achieve desired results. In addition, the processes depicted in the drawings do not necessarily require the specific order shown or a sequential order, to achieve the desired results. In certain implementations, multitasking and parallel processing are also possible or may be advantageous.

Not all steps and units in the above-mentioned processes and system structure diagrams are necessary, and some steps or units may be ignored according to actual needs. The apparatus structure described in the above embodiments may be a physical structure or a logical structure, that is, some units may be implemented by the same physical entity, or some units may be implemented by a plurality of physical entities, respectively, or may be jointly implemented by some components among a plurality of separate devices together.

The detailed description set forth above with reference to the drawings describes exemplary embodiments and does not represent all embodiments that can be implemented or that fall within the scope of the claims. The term “exemplary” as used throughout the description means “serving as an example, instance, or illustration” and does not mean “preferred” or “advantageous” over other embodiments. The detailed description includes specific details for the purpose of providing an understanding of the described technology. However, these techniques can be implemented without these specific details. In some instances, in order to avoid obscuring the concepts of the described embodiments, well-known structures and apparatuses are shown in the block diagram form.

The above description of the present disclosure is provided to enable any person of ordinary skill in the art to implement or use the content of the present disclosure. Various modifications to the present disclosure will be apparent to a person of ordinary skill in the art, and the general principles defined herein may be applied to other modifications without departing from the scope of protection of the present disclosure. Therefore, the present disclosure is not intended to be limited to the examples and designs described herein, but is to be accorded the widest scope consistent with the principles and novel features disclosed herein.

The above-described embodiments are only example embodiments of the present disclosure, rather than being intended to limit the scope thereof, and any modifications, equivalent substitutions, and improvements made without departing from the spirit or principle of the present disclosure shall fall within the scope of protection thereof.

What is claimed is:

1. An application program construction method comprising:
determining a plurality of functional modules that constituting an application program;
attaching a pre-configured communication component to each functional module;
establishing a connection relationship between the functional modules by using the communication components; and
storing the connection relationship in a configuration file.

2. The method according to claim 1, wherein the functional modules comprise threads or processes to implement independent functions.

3. The method according to claim 1, wherein the communication component comprises at least one of an input communication interface and an output communication interface.

4. The method according to claim 3, wherein the communication component further comprises at least one of: a monitoring module, a caching module, and a load balancing module.

5. The method according to claim 1, further comprising modifying execution logic of the application program by modifying the configuration file.

6. An execution method of an application program, the method comprising:
initializing an application program, and loading an application program configuration file;
when a first functional module of the application program receives data, triggering execution of the first functional module; and
sending, by the first functional module, data to a pre-configured port in an output communication interface of the first functional module according to an execution result of the first functional module, so as to trigger execution of a second functional module bound to the port, sending, by the second functional module, data to a pre-configured port in an output communication interface of the second functional module according to an execution result of the second functional module, so as to trigger execution of a third functional module bound to the port, and so on, until execution of the application program ends.

7. A computing device comprising:
at least one processor; and
a memory coupled to the at least one processor, the memory storing instructions, when executed by the at least one processor, causing the at least one processor to:
initialize an application program, and loading an application program configuration file;
when a first functional module of the application program receives data, trigger execution of the first functional module; and
send, by the first functional module, data to a pre-configured port in an output communication interface of the first functional module according to an execution result of the first functional module, so as to trigger execution of a second functional module bound to the port, sending, by the second functional module, data to a pre-configured port in an output communication interface of the second functional module according to an execution result of the second functional module, so as to trigger execution of a third functional module bound to the port, and so on, until execution of the application program ends.

8-9. (canceled)
